(19) United States
(12) Patent Application Publication
(10) Pub. No.: US 2011/0173541 A1
(43) Pub. Date: Jul. 14, 2011

(54) Mass Configuration Tool for Network Telephone Devices

(75) Inventor: Robert John Carlson, Tucson, AZ (US)

(73) Assignee: TeleMatrix, Inc., Colorado Springs, CO (US)

(21) Appl. No.: 12/684,526

(22) Filed: Jan. 8, 2010

(51) Int. Cl. G06F 15/177; G06F 3/048

(52) U.S. Cl. 715/735

(57) ABSTRACT

The subject matter of this specification can be implemented in, among other things, a computer-implemented method for generating a plurality of configuration files including receiving user inputs indicating a structure of buildings in which network telephone devices are located and receiving a user selection of a field to be configured from among fields to be included in the configuration files. The method further includes receiving a user selection of elements from the structure and receiving a user input indicating operations to be performed on the selected elements. The method further includes identifying values for the selected elements for each of the network telephone devices based on the structure and evaluating the operations using the values for the selected elements to determine values for the field for each of the network telephone devices and generating the configuration files for each of the network telephone devices using the values for the field.

### TECHNICAL FIELD

This instant specification relates to generating configuration files for network telephone devices.

### BACKGROUND

Voice over Internet Protocol (VoIP) telephones are one alternative to traditional telephones that use the public switched telephone network (PSTN). VoIP telephones connect to packet-based networks for communication with other telephones. VoIP telephones convert outgoing audio signals into packets for transmission over the packet-based network and convert incoming audio packets into an analog voice signal for playback on the telephone. Packet-based networks can include various Internet Protocol (IP) networks, such as local area networks (LANs), wide area networks (WANs), and the Internet.

Media gateways allow communication between VoIP telephones and telephones connected to the PSTN. The media gateways can convert packets sent across the packet-based network into analog voice signals for transmission across the PSTN. Media gateways can store information relating to the VoIP telephones connected to the gateway in order to facilitate routing of calls to and from VoIP telephones, such as the IP address and unique identifier of the VoIP telephone. VoIP telephones store configuration settings that help facilitate communication between the telephone and the media gateway.

### SUMMARY

In general, this document describes generating configuration files for network telephone devices. In a first aspect, a computer-implemented method for generating a plurality of configuration files that are individually customized for a corresponding plurality of network telephone devices for voice communication includes receiving one or more user inputs in a graphical user interface (GUI) on a computing device indicating a structure of one or more buildings in which the network telephone devices are located. The method further includes receiving a user selection in the GUI of a field to be configured from among a plurality of fields to be included in the configuration files. The method further includes receiving a user selection in the GUI of one or more elements from the structure. The method further includes receiving a user input in the GUI indicating one or more operations to be performed on the selected elements. The method further includes identifying values for the selected elements for each of the corresponding network telephone devices based on the structure. The method further includes evaluating the operations using the values for the selected elements to determine values for the field for each of the corresponding network telephone devices. The method further includes generating the configuration files for each of the corresponding network telephone devices using the corresponding values for the field. The method further includes storing the configuration files in a memory.

Implementations can include any, all, or none of the following features. The network telephone devices can include one or more voice over Internet Protocol (IP) telephones. The network telephone devices can include one or more voice over Internet Protocol (IP) telephony adapters for corresponding analog telephones. The fields can include for each of the corresponding network telephone devices one or more of a static IP address, a unique configuration identifier, a network host name, a display message, a telephone number, a telephone extension, a registration identifier, and a registration password. The elements from the structure can include one or more of identifiers of the buildings, identifiers of one or more floors in the buildings, identifiers of one or more rooms on the floors, identifiers of one or more telephone locations in the rooms, and identifiers of one or more types of telephones. One or more of the identifiers of the buildings, the identifiers of the floors, the identifiers of the rooms, and the identifiers of the telephone locations can be numeric. The operations can include one or more mathematical operations performed on the numeric ones of the identifiers of the buildings, the identifiers of the floors, the identifiers of the rooms, and the identifiers of the telephone locations. The operations can include one or more logic operations. The operations can include one or more text manipulation operations. The method can include receiving a user input that includes one or more phone templates having default values for the fields of the configuration files. Receiving the user inputs indicating the structure can include receiving a room type that specifies a number of telephone locations in rooms having the room type and ones of the phone templates assigned to each of the telephone locations. Receiving the user inputs indicating the structure can include receiving one or more ranges of identifiers of rooms having the room type. The method can include receiving a user request in the GUI to copy at least one of the ranges to another range. The method can include transmitting the configuration files to a file server.

In a second aspect, a computer program product, encoded on a computer-readable medium, operable to cause one or more processors to perform operations for generating a plurality of configuration files that are individually customized for a corresponding plurality of network telephone devices for voice communication includes receiving one or more user inputs in a graphical user interface (GUI) on a computing device indicating a structure of one or more buildings in which the network telephone devices are located. The computer program product further includes receiving a user selection in the GUI of a field to be configured from among a plurality of fields to be included in the configuration files. The computer program product further includes receiving a user selection in the GUI of one or more elements from the structure. The computer program product further includes receiving a user input in the GUI indicating one or more operations to be performed on the selected elements. The computer program product further includes identifying values for the selected elements for each of the corresponding network telephone devices based on the structure. The computer program product further includes evaluating the operations using the values for the selected elements to determine values for the field for each of the corresponding network telephone devices. The computer program product further includes generating the configuration files for each of the corresponding network telephone devices using the corresponding values for the field. The computer program product further includes storing the configuration files in a memory.

Implementations can include any, all, or none of the following features. The elements from the structure can include one or more of identifiers of the buildings, identifiers of one or more floors in the buildings, identifiers of one or more rooms on the floors, identifiers of one or more telephone locations in the rooms, and identifiers of one or more types of telephones. One or more of the identifiers of the buildings, the identifiers of the floors, the identifiers of the rooms, and the identifiers of the telephone locations can be numeric. The operations can include one or more mathematical operations performed on the numeric ones of the identifiers of the buildings, the identifiers of the floors, the identifiers of the rooms, and the identifiers of the telephone locations. The operations can include one or more logic operations. The operations can include one or more text manipulation operations. The computer program product can include receiving a user input that includes one or more phone templates having default values for the fields of the configuration files. Receiving the user inputs indicating the structure can include receiving a room type that specifies a number of telephone locations in rooms having the room type and ones of the phone templates assigned to each of the telephone locations. The computer program product can include receiving one or more ranges of identifiers of rooms having the room type. The computer program product can include receiving a user request in the GUI to copy at least one of the ranges to another range.

The systems and techniques described here may provide one or more of the following advantages. First, a system can provide a graphical user interface for that minimizes an amount of time spent configuring large numbers of network telephone devices. Second, a system can provide a predetermined set of operations or rules that guide a user in configuring large numbers of network telephone devices. Third, a system can generate configuration files for large numbers of network telephone devices based on patterns specified by a user.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of a system for mass configuration of network telephone devices.

FIGS. 2-5 are examples of graphical user interfaces (GUIs) for mass configuration of network telephone devices.

FIG. 6 is a flow chart that shows an example of a process for mass configuration of network telephone devices.

FIG. 7 is a schematic diagram that shows an example of a computing system that can be used in connection with computer-implemented methods and systems described in this document.

Like reference symbols in the various drawings indicate like elements.

### DETAILED DESCRIPTION

This document describes systems and techniques for generating multiple configuration files for a number of network telephone devices based on patterns specified by a user. The network telephone devices are located in one or more buildings. Values associated with the structure of the buildings (e.g., a floor number, room number, or other building division, such as a cubicle) are used in the evaluation of operations in the user-specified patterns. The results of the evaluated user-specified patterns are stored as values for data fields in the configuration files for the network telephone devices.

In some implementations, one or more user inputs identify phone templates that contain default values for the data fields in the configuration files for the corresponding network telephone devices. Each room has an associated room type that specifies one or more phone templates corresponding to the network telephone devices in the room. The user can select one or more ranges of rooms in the buildings and assign a room type to the range of rooms. This allows the user to configure a large number of network telephone devices with a minimum number of user inputs

For example, a user can configure network telephone devices, such as VoIP telephones, for a hotel complex from an administrative computer. The computer presents a GUI with input controls which allow the user to specify the structure of the hotel complex. For example, the GUI can receive an input from the user indicating that the hotel has three floors with twelve rooms on each floor. The GUI also presents input control that guide the user in specifying a pattern or rule for configuring fields in the configuration files. For example, the GUI can receive a user input indicating that a data field for the static IP addresses of the VoIP telephones is based on the floor number and room number of the VoIP telephones with the first two octets of the IP address being constant as “10.60”. The GUI identifies the floor numbers and room numbers for each of the VoIP telephones and concatenates the floor and room numbers on the end of the first two octets of the IP address as the third and fourth octets, respectively. In this example, the GUI calculates IP addresses for VoIP telephones located on the second floor in room ten and on the first floor in room six as “10.60.2.10” and “10.60.1.6,” respectively. The GUI generates corresponding configuration files for the VoIP telephones using the calculated IP addresses as well as values resulting from other patterns and from default values.

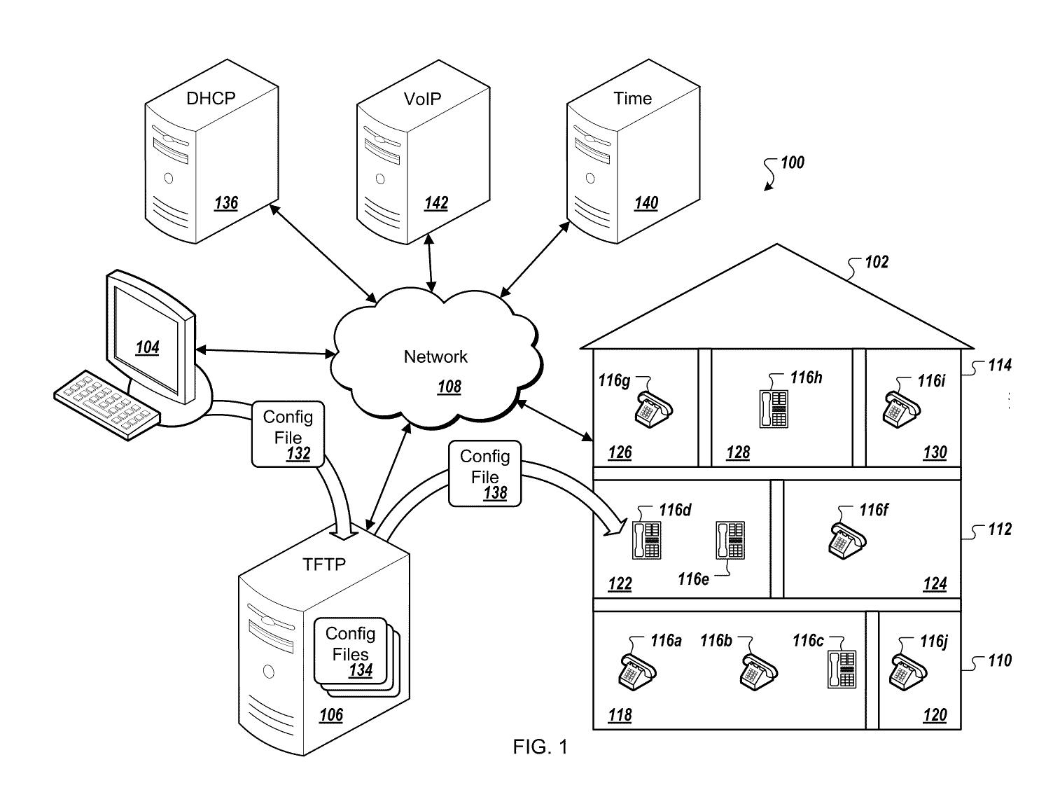

FIG. 1 is a schematic diagram that shows an example of a system 100 for mass configuration of network telephone devices. The system 100 includes at least one building 102 with multiple network telephone devices, an administrator console 104 for generating configuration files for the network telephone devices, a file server 106 for storing the configuration files, and a network 108 for transferring the stored configuration files to the network telephone devices. The network 108 can, for example, include a wide area network (WAN), local area network (LAN), an intranet, the Internet, a telephone connection, or any other form of connection. The building 102 is a structure with multiple network telephone devices, such as a hotel or hotel complex. In other implementations, the building 102 can be an office building, a call center, or a university, to name a few examples.

In the example shown here, the building 102 includes three floors, a first floor 110, a second floor 112, and a third floor 114, and multiple network telephone devices 116a-j. The network telephone devices 116c, 116d, 116e, and 116h are VoIP telephones and the network telephone devices 116a, 116b, 116g, 116i, and 116j are analog telephones with VoIP telephony adapters. In some implementations, all of the network telephone devices 116a-j are VoIP telephones. In other implementations, the network telephone devices 116a-j are analog telephones with VoIP telephony adapters, such that the adapters provide communication between the analog telephones and the network 108.

The first floor 110 includes a lobby 118 and an office 120. The second floor 112 includes a guest suite 122 and a standard guest room 124. The third floor includes multiple standard guest rooms 126, 128, and 130. In other implementations, a structure for which telephones are configured can include numbers and types of buildings, floors, rooms, and telephones that are different than those shown in the examples here.

The administrator console 104 can be used to input the patterns and building structures used to create the configuration files for the network telephone devices 116a-j. The administrator console 104 creates a separate configuration file for each of the network telephone devices 116a-j. Once the administrator console 104 creates a configuration file 132, the administrator console 104 sends the configuration file 132 to the file server 106 through the network 108. Similarly, the administrator console 104 can also generate and send an updated configuration file to the file server 106. The administrator console 104 can, for example, be a laptop computer, a desktop computer, a server, or a mobile computing device, to name a few examples. The administrator console 104 can be located in the building 102 or in a building separate from the building 102.

The file server 106 provides a plurality of configuration files 134 to corresponding ones of the network telephone devices 116a-j. The file server 106 can use file and/or data transfer systems such as trivial file transfer protocol (TFTP), hyper text transfer protocol (HTTP), and/or file transfer protocol (FTP),and Structured Query Language (SQL). The file server 106 can store the configuration files 134 in a database or in a file system. The configuration files 134 include a configuration file for each of the network telephone devices 116a-j. In some implementations, the file server 106 and the administrator console 104 are co-located and operate in the same computer device. Alternatively, the file server 106 can run on a computer device separate from that of the administrator console 104. In some implementations, the file server 106 includes configuration files for network telephone devices located at more than one building. In other implementations, a file server is used in each building that includes network telephone devices.

After the configuration files 134 have been generated and stored at the file server 106, a network telephone device, such as the network telephone device 116d, that is coming online queries the network 108 for a Dynamic Host Configuration Protocol (DHCP) server, such as a DHCP server 136. The network telephone device 116d sends a request to the DHCP server 136 for a temporary IP address and the IP address of the file server 106. Generally, the network telephone device 116d prompts a person at the phone during the setup for a configuration identification (ConfigID). In some implementations, the ConfigID is the telephone extension of the telephone number for the network telephone device 116d. The network telephone device 116d uses the IP address of the file server 106 to locate the file server 106 on the network 108 and sends a request to the file server 106 for a configuration file 138. The request includes the ConfigID. The file server 106 locates the configuration file 138 in the database of the configuration files 134 using the ConfigID and sends the configuration file 138 to the network telephone device 116d via the network 108.

In certain implementations, the network telephone device 116d includes a display, such as a liquid crystal display (LCD), for prompting the person during the setup for the ConfigID. In other implementations, the network telephone device 116d uses sequences of tones to prompt the person during setup for input.

In some implementations, the fields in the configuration files 134 can include a sequence or version number for the particular configuration file. When an updated configuration file is created by the administrator console 104, the sequence number is incremented and saved in the updated configuration file. In certain implementations, each of the network telephone devices 116a-j is set to check periodically for updated configuration files from the file server 106 by comparing the sequence number of the current configuration of the network telephone device with the sequence number of the configuration file on the file server 106. If one of the network telephone devices 116a-j finds an updated configuration file, that network telephone device is updated with the new configuration settings. For example, each of the network telephone devices 116a-j can check for updated configuration files every time the device is powered on. Alternatively or in addition, each of the network telephone devices 116a-j can be set to poll the file server 106 at specific times during the day or after a certain amount of time has passed since the last check (e.g., every two hours). In other implementations, the administrator console 104 sends a multicast signal across the network 108 that instructs the network telephone devices 116a-j to poll the file server 106 for an updated configuration file.

The system 100 includes a time server 140, such as a network time protocol (NTP) or simple network time protocol (SNTP) server. The time server 140 supplies the current Universal Coordinated Time (UTC) to the network telephone devices 116a-j. In some implementations, each of the network telephone devices 116c, 116d, 116e, and 116h includes an LCD display that presents a message to a user. For example, the LCD display can present the current time and date. The LCD display can present to a user the device IP address, the device ConfigID, the device telephone number, the device telephone extension, a device menu, a device greeting, or a combination of the previously mentioned options. In some implementations, the time server 140 is located on the same computer device as the DHCP server 136 and/or the file server 106.

The system 100 includes a VoIP server 142, such as a SIP server. The VoIP server 142 facilitates communication between the network telephone devices 116a-j and telephones outside the system 100. Each of the network telephone devices 116a-j registers with the VoIP server 142 after receiving a configuration file. The VoIP server 142 includes a database of IP addresses and unique identifiers for each of the network telephone devices 116a-j. When a call is made by one of the network telephone devices 116a-j, the VoIP server 142 routes the call to the intended destination. For example, a user of the network telephone device 116f can make a call to the network telephone device 116c in the lobby 118. The network telephone device 116f connects to the VoIP server 142 providing destination information, such as the extension of the network telephone device 116c. The VoIP server 142 determines the IP address of the network telephone device 116c based upon a lookup in the database located on the VoIP server 142 and routes the call to the network telephone device 116c. In some implementations, the VoIP server 142 is a media gateway. In some implementations, the VoIP server 142 is located on the same computer device as the DHCP server 136 and/or the file server 106.

In certain implementations, the administrator console 104 includes phone templates. In some implementations, an initial phone template can be generated by manually configuring a phone and then outputting the configuration to a file. In other implementations, phone templates can be created at the administrator console 104. The administrator console 104 includes a phone template for each type of phone in the building 102 being configured by the administrator console 104. Each phone template can include different default settings for the values of the fields in the configuration files. For example, a phone template for a standard room phone may have a different set of speed dial numbers than a phone template for a lobby phone. The administrator console 104 includes a database or other stored list of elements that describe the structure of the building 102. For example, elements can include identifiers of one or more floors in the buildings, identifiers of one or more rooms on the floors, identifiers of one or more telephone locations in the rooms, identifiers of one or more types of telephones, and identifiers of one or more room types.

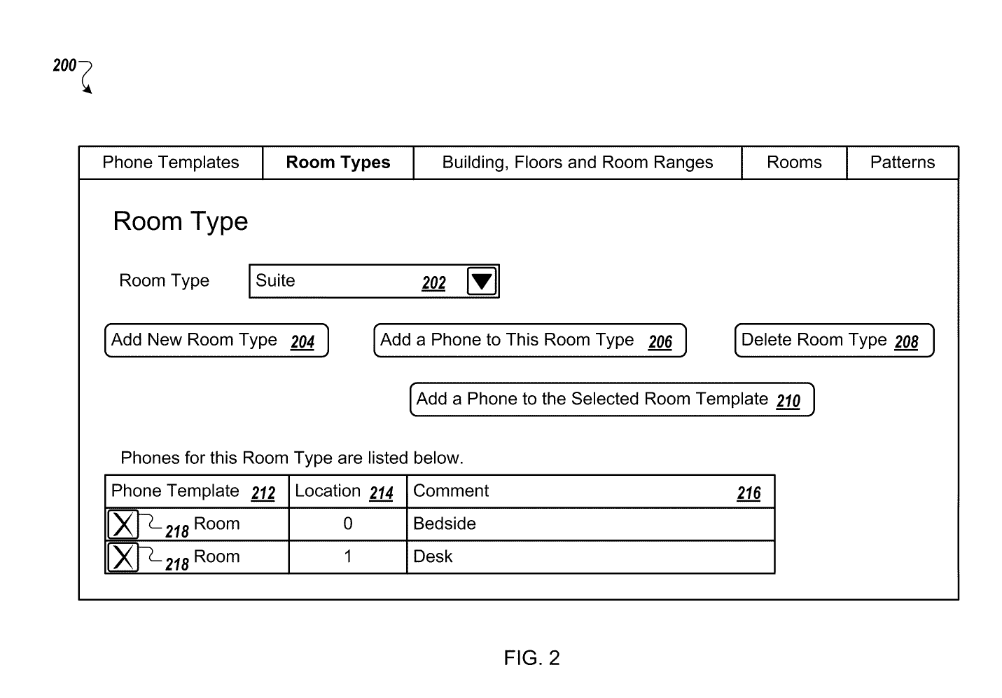

FIG. 2 is an example of a GUI 200 for configuring a room type. The GUI 200 can be presented to a user at the administrator console 104. The GUI 200 presents information for one or more room types, including the number of phones in each of the room types, the locations of the phones, and the types of phones. The GUI 200 includes a room type selection control 202. A user can select from a pull-down list of preexisting room types using the room type selection control 202 and then configure the various settings for the selected room type.

The GUI 200 also includes an add new room type button 204, an add phone to this room type button 206, a delete room type button 208, and an add phone to selected room template button 210. The add new room type button 204 allows a user to create a new room type. The add phone to this room type button 206 is used to add one or more phones to the selected room type. Each room type includes at least one phone. The delete room type button 208 deletes the currently selected room type from the database on the administrator console 104. The add phone to selected room template button 210 allows a user to add one or more phones to a currently selected template.

The GUI 200 includes a table of information for the phones in the selected room type. The table includes a phone template identifier column 212, a phone location identifier column 214, and a phone comment column 216. The phone template identifier column 212 shows the identifier of the phone template for each phone in the selected room type and allows a user to select a phone template for each of the phones included in the selected room type. The phone location identifier column 214 shows the identifier of the phone location for each phone in the selected room type and allows a user to input or select a location identifier for each of the phones in the selected room type. The values for the phone location identifier column 214 can, for example, be stored as either numbers or as text. The phone comment column 216 allows a user to enter general information about the phones, such as a description of the phones or a description of the location of the phones. One or more delete phone buttons 218 allow a user to delete phones from the currently selected room type.

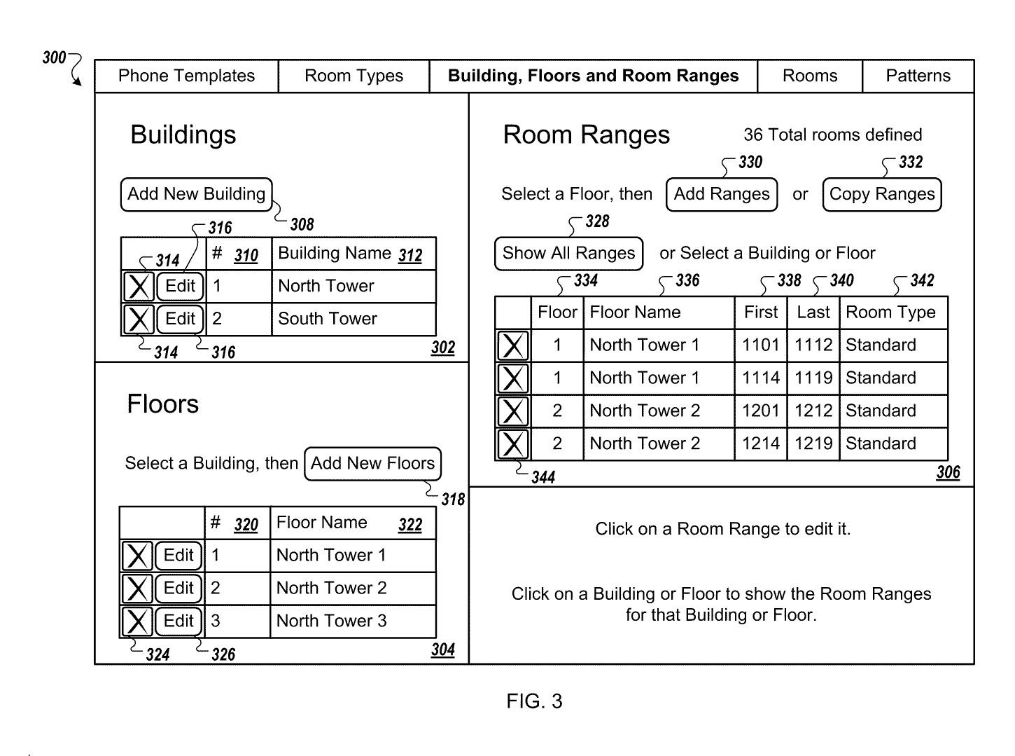

FIG. 3 is an example of a GUI 300 for specifying structural elements or divisions within one or more buildings. In some implementations, the GUI 300 is presented to a user at the administrator console 104. The GUI 300 allows a user to add new buildings or elements within a building and to view building settings. The GUI 300 allows users to specify the number of floors in each building and the number of rooms on each floor. The GUI 300 includes a buildings panel 302, a floors panel 304, and a room ranges panel 306.

The buildings panel 302 includes an add new building button 308 as well as a table of building information including a building number column 310 and a building name identifier column 312. The add new building button 308 allows a user to add one or more buildings to the database of building information on the administrator console 104. A user can select a building by clicking on the respective cell in the building number column 310 or the building name identifier column 312. Buildings can be deleted from the database on the administrator console 104 by selecting one or more delete building buttons 314 associated with the respective buildings. A user can change the values in the building number column 310 or the building name identifier column 312 by selecting one or more edit building buttons 316 associated with the respective buildings. The numeric characters for the values in the building number column 310 can be stored as either numbers or as text.

Each building can include one or more floors. Floor information for the building that is currently selected in the buildings panel 302 is presented in the floors panel 304. After a building is added to the database on the administrator console 104, a user can add floors by selecting the building in the buildings panel 302 and then selecting an add new floors button 318. For example, if a user selects the “North Tower”, the floors panel will display information relating to the floors located in the “North Tower”. The floors panel includes a table of information describing the floors for the selected building. The table includes a floor number column 320 and a floor name identifier column 322. A user can delete floors by selecting one or more delete floor buttons 324 and edit floor information by selecting one or more edit floor buttons 326. The floor number column 320 is unique for each building such that each building can only have one first floor, but all buildings can have a first floor. The numeric characters for the values in the floor number column 320 can be stored in memory as either numbers or as text. In some implementations, the floor name identifiers are unique among the buildings such that there is only one floor named, for example, “North Tower 1”.

The room ranges panel 306 allows a user to specify one or more ranges of rooms that have similar configurations. In some implementations, this minimizes the number of inputs made by the user because the user does not need to input information for each room individually. The room ranges panel 306 includes a show all ranges button 328, an add ranges button 330, and a copy ranges button 332. The show all ranges button 328 allows a user to view all of the room ranges for the buildings in the database. Alternatively, a user can select a building in the buildings panel 302 or a floor in the floors panel 304 to view only the room ranges associated with the selected building or floor. The room ranges panel 306 presents a user with a table that shows information for the rooms ranges. The table includes a floor number column 334, a floor name identifier column 336, a first room number column 338, a last room number column 340, and a room type identifier column 342. A range of rooms is defined by the first room number in the range and the last room number in the range as specified in the first room number column 338 and the last room number column 340.

In the example shown here, each of the rooms in a range is on the same floor as identified by the floor number column 334 and in the same building as identified by the floor name identifier column 336. Alternatively, in the case where the patterns used to determine values for the configuration file fields do not depend on both the room number and the floor or building, a room range can include multiple floors and/or buildings. In general, the structural elements to be used in the patterns define which structural elements the user must specify in the GUI 200 and the GUI 300.

Each of the rooms in a particular range of rooms have a room type in common as shown by the room type identifier column 342. Accordingly, each of the rooms in a particular range or rooms includes a same number of network telephone devices and one or more same types of network telephone devices. The same types of network telephone devices in each of the rooms in a particular range or rooms all have a similar configuration, such that the fields that are different in the configuration files among the network telephone devices in the range of rooms can be determined using a pattern.

A user can select the add ranges button 330 to add a new range of rooms to the currently selected building. The user is presented with a graphical user interface that allows selection of a floor identifier, a first room number for the range, a last room number for the range, and a room type. In some implementations, selection of a floor identifier in the floors panel 304 identifies the floor and the user only enters the starting room number, ending room number, and room type. In certain implementations, users can enter multiple ranges of rooms for the same room type at the same time. A user can delete a range of rooms by selecting a delete room range button 344.

A user can select the copy ranges button 332 to copy a range of rooms and the associated room type from one floor to another. For example, the first floor of the North Tower building includes rooms “1101” through “1112” that have a “standard” room type. A user adds a range for the rooms “1101” through “1112” by selecting the add ranges button 330 and entering the starting and ending room numbers. The second floor of the North Tower includes an identical layout as the first floor. The user can select the copy ranges button 332 and then select the building, floor, and range to copy. In other implementations, the user selects the room range that will be copied, selects the copy ranges button 332, and then enters information for the desired floor the range is to be copied to. Alternatively, the user can select the add ranges button 330 and enter the associated information for the room range. In some implementations, a user identifies the floor being copied, the floor being created, and the staring room number of the new floor after selection of the copy ranges button 332. Room ranges can be edited by clicking on the respective room range.

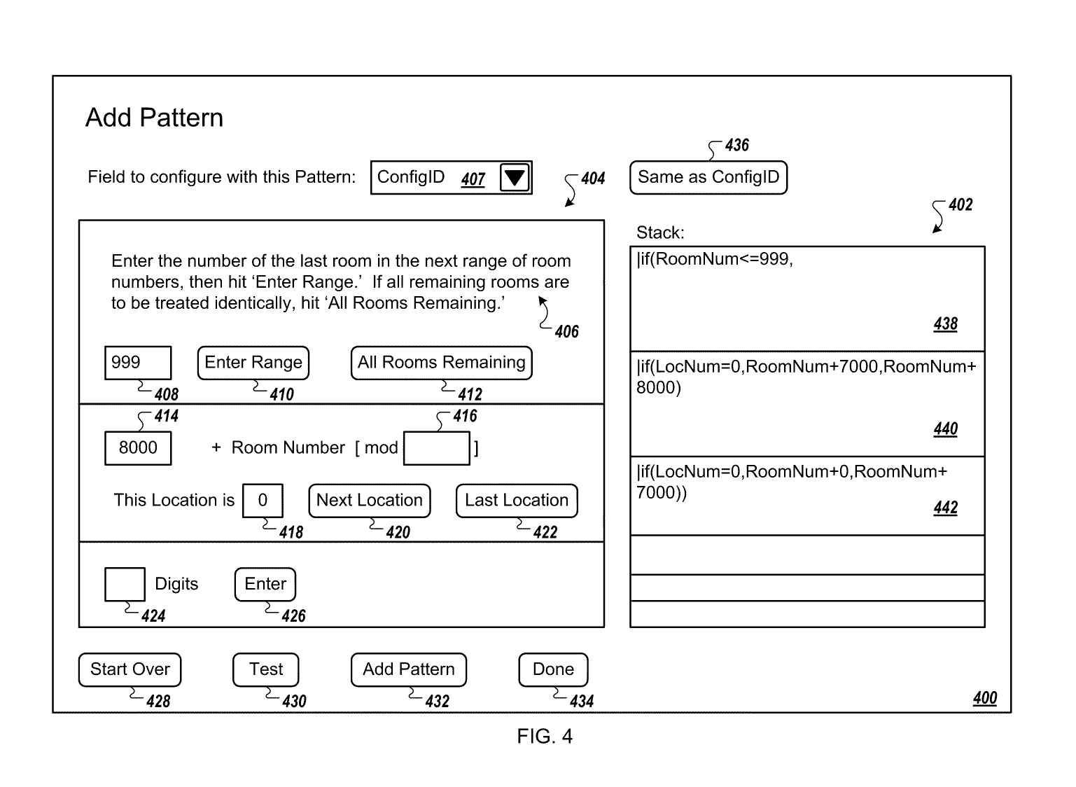

FIG. 4 is an example of a GUI 400 for creating a pattern used to define variable fields in the configuration files for the network telephone devices 116a-j, such as a ConfigID field. A pattern is a formula used to calculate the value that will be put in the field in the configuration file for a particular network telephone device. The formula for the pattern is presented to a user in a stack 402 and can be edited with an interface 404. The stack 402 shows the operations from the formula as the formula is edited. The first of the operands and operators in the formula are at the top of the stack 402 and the last of the operands and operators are at the bottom of the stack 402. A help display 406 presents users with text that leads the user through the process of constructing a formula.

The GUI 400 includes a field selection control 407. The field selection control 407 allows a user to select a configuration file field for which to create a formula. The formula is used to generate the different field values for the configuration files of the network telephone devices. For example, when creating the configuration files for the network telephone devices 116a-j, a user can create a formula for the ConfigID instead of manually entering the ConfigID into each of the individual configuration files. In some implementations, each of the configuration file fields that can be selected in the field selection control 407 has a different set of available operands and operators in the interface 404.

The interface 404 for the ConfigID field includes a room range field 408, an enter room range button 410, and an all rooms remaining button 412. A user can input a room number in the room range field 408 and then select the enter room range button 410 to specify a range of rooms to which the pattern will apply. A user can select the all rooms remaining button 412 to configure the pattern to be used for the rooms that are outside of the previously specified range. For example, as shown in a first portion 438 of the pattern, while configuring the ConfigID field the user has specified that a first condition for the ConfigID applies to the range of rooms up to and including “999”. In some implementations, a user can make multiple inputs in the room range field 408 and select the enter room range button 410 multiple times to specify multiple ranges of rooms and corresponding patterns. In some implementations, the range of rooms can include a starting room number and an ending room number. In some implementations, the GUI 400 includes a selection control (not shown) that allows the user to select form among the ranges of rooms that were entered in the GUI 300.

The interface 404 includes an addend field 414, a divisor field 416, a location field 418, a next location button 420, and a last location button 422 for inputting the operands and operators of the formula for the ConfigID. The user can enter a value to add to the room number in the addend field 414. The user can enter a divisor in the divisor field 416 in order to perform modular arithmetic on the sum of the room number and the value of the addend field 414. The location field 418 is used to enter a telephone location to which the portion of the formula applies. For example, if a room has two network telephone devices, the first network telephone device is at location “0” and the second device is at location “1.” The next location button 420 is used to enter the addend and divisor for the location currently entered into the location field 418. The last location button 422 is used to enter the addend and divisor for any remaining locations that are not yet configured. For example, as shown in a second portion 440 of the pattern, for room numbers up to and including “999”, if the location is the first location (zero), then ConfigID is the room number plus seven thousand. Otherwise if the location is not the first location, then the ConfigID is the room number plus eight thousand. Furthermore, as shown in a third portion 442 of the pattern, for room numbers over “999”, if the location is the first location, then the ConfigID is the room number itself. Otherwise, if the location is not the first location, then the ConfigID is the room number plus seven thousand.

The interface 404 includes a digits field 424 and a enter digits button 426 for formatting values in the stack 402. The digits field 424 is used to enter the number of digits required at a particular stage in the formula. For example, while creating a formula for the ConfigID, a user can enter a value of “4” and select the enter digits button 426 so that the ConfigID includes four digits total with leading zeros added to the ConfigID as needed to bring the total number of digits up to four if the formula results in less than four digits.

The GUI 400 includes a start over button 428, a test formula button 430, an add pattern button 432, and a done button 434. The start over button 428 is used to reset the stack 402 by removing all formula values currently held in the stack 402. The test formula button 430 tests the formula currently entered in the stack 402. In some implementations, errors or other prompts are presented to a user as needed in order to correct any potential problems with the formula entered in the stack 402. The add pattern button 432 adds the current formula pattern to the database on the administrator console 104. In some implementations, the pattern is tested before it is added to the database. A user can be presented with a prompt for the pattern name, for example, before the pattern is saved to the database. The done button 434 closes the GUI 400. In certain implementations, selection of the done button 434 tests the current pattern and saves it to the database on the administrator console 104.

The GUI 400 includes a same-as-ConfigID button 436. Selection of the same-as-ConfigID button 436 copies the formula of the ConfigID field to the field that is currently selected in the field selection control 407.

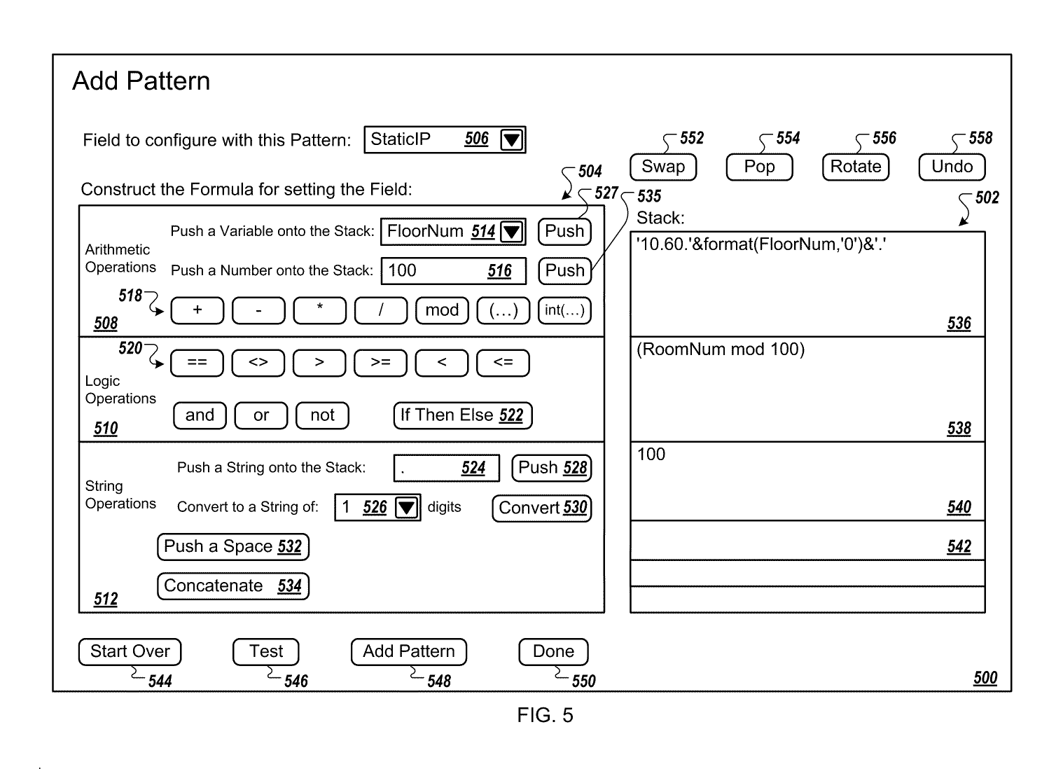

FIG. 5 is an example of a GUI 500 for creating a pattern used to define variable fields in the configuration files for the network telephone devices 116a-j, such as a static IP address. The GUI 500 includes a stack 502, a user interface 504, and a field selection control 506. The formula for the pattern is presented to a user in the stack 502 and is edited with the user interface 504. The field selection control 506 allows a user to select which field of the configuration files to create a formula for. The field selection control 506 shows that the user is currently editing the pattern for the static IP address field.

When the static IP address is selected in the field selection control 506, the user interface 504 presents an arithmetic operations panel 508, a logic operations panel 510, and a string operations panel 512 to the user. The arithmetic operations panel 508 includes a variable selection control 514, an arithmetic value field 516, and one or more buttons 518. The variable selection control 514 allows a user to select and push a particular variable onto the stack 502 during creation of a formula. For example, the floor number, the room number, or the telephone location number of the network telephone device 116d can be used during configuration of a static IP address for the network telephone device 116d. The arithmetic value field 516 can be used to enter a divisor for modulus arithmetic or other operands. For example, the arithmetic value field 516 can be used to enter a value to add to a room number. The arithmetic value field 516 is used to enter operands for the formulas that generate the values for the fields in the configuration files. The buttons 518 allow the user to add one or more arithmetic operators to the stack 502, such as addition, subtraction, multiplication, division, modular arithmetic, parentheses for specifying an order for operations, and a command for casting a text value to an integer value.

The logic operations panel 510 includes one or more logic operator buttons 520 for adding logic operations to the formula in the stack 502. The logic operations panel 510 includes a conditional button 522 for adding one or more if-then-else conditional statements to the formula in the stack 502. The logic operator buttons 520 include controls for adding one or more relational operators such as equality, inequality, less-than, less-than-or-equal-to, greater-than, and greater-than-or-equal-to to the formula. The logic operator buttons 520 also include controls for adding one or more logical operators such as logical conjunctions (“And”), logical disjunctions (“Or”), or logical negations (“Not”) to the formula. In some implementations, logical disjunctions can be either inclusive or exclusive.

The string operations panel 512 includes a string field 524, and a number-of-digits selection control 526. After entering a string into the string field 524, the user can select a push string button 528 to push the entered string onto the stack 502. String values can, for example, be used in a formula for calculating values in configuration files. The number-of-digits selection control 526 allows a user to convert variables to strings with the selected number of digits. For example, during configuration of the static IP address of the network telephone devices 116a-j, the user can select the variable FloorNum in the variable selection control 514 and a push button 527 to push the FloorNum variable onto the stack 502. The user can then select a total number of digits of one in the number-of-digits selection control 526 and a convert button 530. This series of operations converts the FloorNum variable to a one digit series of text characters (e.g., a text string). The portion of the formula resulting from these operations is shown in a top portion 536 of the stack 502 as “format(FloorNum,‘0’)”. During generation of configuration files with this portion of the formula, when the variable FloorNum is evaluated, the number value is converted to text with one digit and used as part of the StaticIP field in the configuration files for the network telephone devices 116a-j.

The string operations panel 512 includes a push space button 532 and a concatenate button 534. The push space button 532 is used to push a space text character onto the stack 502. The concatenate button 534 is used to concatenate two series of text characters together. For example, at a previous point in time during entry of the formula, the user entered the text ‘10.60.’ into the string field 524 and selected a push button 535 to push the text onto the stack 502 in the top portion 536. The user then performed the actions described above to push and format the FloorNum in a middle portion 538 of the stack 502. Finally, the user selects the concatenate button to concatenate the ‘10.60.’ text in the top portion 536 with the formatted FloorNum text in the middle portion 538 and the resulting concatenation is placed in the top portion 536. The concatenation is represented by the ampersand symbol between the ‘10.60.’ text and the text for the formatted FloorNum. Subsequently, the user pushes text including a period onto the stack 502 and concatenates the period with the existing concatenated text as shown by the formula in the top portion 536.

After the concatenation of the text currently shown in the top portion 536, the user pushes the RoomNum variable onto the stack 502 in the middle portion 538. The user then pushes the number one hundred onto the stack 502 in a bottom portion 540. Next, the user selects a modulo operation (mod) from among the buttons 518 to determine a remainder after dividing the RoomNum by the number one hundred. The resulting modulo operation and the operands are placed in the middle portion 538. Finally, the user selects the order of operations control (parentheses) in the buttons 518 to place parentheses around the modulo operation indicating that it is performed before other operations around it. The resulting portion of the formula is currently shown in the middle portion 538.

As described above, new operators and operands are pushed onto a next empty portion 542 at the bottom of the stack 502. For example, after entering the modulo operation, the user can then push the number one hundred onto the stack 502 in the bottom portion 540 by entering one hundred in the arithmetic value field 516 and then selecting the push button 535. The resulting portion of the formula is currently shown in the bottom portion 540. Next, the user can select an addition operation from among the buttons 518 to add the result of the modulo operation in the middle portion 538 with the number one hundred in the bottom portion 540. The resulting portion of the formula is then placed in the middle portion 538 as “(RoomNum mod 100)−100”.

To complete a formula, the portions of the stack 502 are concatenated or combined using operators so that the complete formula is presented in the top portion 536 of the stack 502. For example, the user can format the result of the modulo and addition operations as a single digit of text by selecting the number of digits in the number-of-digits selection control 526 and the convert button 530. The resulting portion of the formula is placed in the middle portion 538 as “format((RoomNum mod 100)+100),‘0’)”. The user can then concatenate that result with the text in the top portion 536 by selecting the concatenate button 534. The resulting formula is placed in the top portion 536 as “‘10.60.’&format(FloorNum,‘0’)&‘.’& format((RoomNum mod 100)+100),‘0’)”.

In general, the push button 527, the push string button 528, the push space button 532, and the push button 535 each add one item (a variable, a string, a space, or a number, respectively) to the last unused entry in the stack 502. The ( . . . ) and int( . . . ) operations in the buttons 518 and the convert button 530 each operate on the last item on the stack 502 and place the result back in the last position on the stack 502. With the exception of the conditional button 522, the mathematical operations in the buttons 518, the logic operator buttons 520, and the concatenate button 534 remove the last two items from the stack 502 and place the result in the last position on the stack 502. Selecting these operations results in decreasing the number of items on the stack 502 by one. The conditional button 522 removes the last three items from the stack 502 and places the result in the last position on the stack 502. Selecting the conditional button 522 results in decreasing the number of items on the stack 502 by two.

The GUI 500 includes a swap button 552, a pop button 554, a rotate button 556, and an undo button 558 for modification of the stack 502. The swap button 552 swaps or exchanges the positions of the last two entries on the stack 502. For example, selection of the swap button 552 can swap the modulo operation shown in the middle portion 538 with the number one hundred shown in the bottom portion 540 of the stack 502. The pop button 554 clears the last entry of the stack 502. For example, selection of the pop button 554 can clear the number one hundred shown in the bottom portion 540 of the stack 502. The rotate button 556 exchanges the positions of the last three portions of the stack 502. For example, the user can select the rotate button 556 to place the value from the top portion 536 in the middle portion 538, the middle portion 538 in the bottom portion 540, and the bottom portion 540 in the top portion 536. In some implementations, all portions of the stack are exchanged during rotation rather than the last three. In some implementations, the direction of rotation is opposite to that described above or another control exists for rotation in the other direction. The undo button 558 undoes the most recent change to the stack 502. The undo button 558 can be selected repeatedly to undo a sequence of changes to the stack 502.

The GUI 500 includes a start over button 544, a test pattern button 546, an add pattern button 548, and a done button 550. Selection of the start over button 544 clears the stack 502, removing all values from all portions of the stack 502.

The test pattern button 546 tests the formula that is currently in the stack 502. For example, selection of the test pattern button 546 can evaluate the result of the formula for a particular location, such as building one, floor two, room ten, and room location zero. In some implementations, the test pattern button 546 tests the formula as presented in all of the portions of the stack 502. In other implementations, the test pattern button 546 only tests the portion of the formula that is in the top portion 536 of the stack 502.

The add pattern button 548 adds the current formula to a database on the administrator console 104. In other implementations, the add pattern button 548 adds the current formula to a database on the file server 106. After selection of the add pattern button 548, in some implementations, a user is prompted to enter the name of the pattern so that another pattern may be defined. In some implementations, the GUI 500 exits. The done button 550 exits the GUI 500. For example, selection of the done button 550 tests the formula held in the stack 502 and saves the formula before exiting the GUI 500.

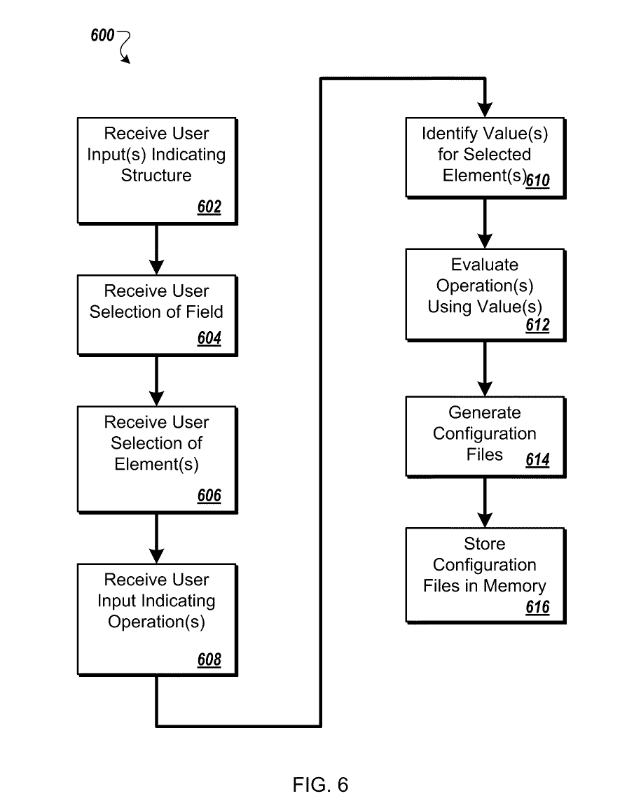

FIG. 6 is a flow chart that shows an example of a process 600 for mass configuration of network telephone devices. The process 600 may be performed, for example, by a system such as the system 100 and the GUIs 200, 300, 400, and 500. For clarity of presentation, the description that follows uses the system 100 and the GUIs 200, 300, 400, and 500 as the basis of an example for describing the process 600. However, another system, or combination of systems, may be used to perform the process 600.

The process 600 begins with receiving (602) one or more user inputs in a GUI on a computing device indicating a structure of one or more buildings in which a plurality of network telephone devices are located. For example, the user can indicate that the building 102 contains three floors, one or more ranges of room numbers, and one or more telephone locations in each of the rooms. The GUIs 200 and 300 can be used to enter the structural information. For example, the user can specify the ranges of room numbers on each floor and the room types for the ranges of rooms. The GUI 200 can be used to enter the room type information, including the number of telephones located in rooms with that room type and a description of the locations of the telephones.

The process 600 receives (604) a user selection in the GUI of a field to be configured from among a plurality of fields to be included in a plurality of configuration files. Each of the configuration files are individually customized for a corresponding one of the network telephone devices. For example, a user selects StaticIP from the field selection control 506 in the GUI 400 in order to configure a pattern that is evaluated for setting the static IP address of one or more of the network telephone devices 116a-j. The fields in the configuration file can include a configuration ID, a static IP address, a file server address, a time server address, an SIP server address, a password for accessing the particular network telephone device, a static gateway address, a domain name server (DNS) address, a time zone, a port number, a phone number, a phone extension, a proxy address, a display message, a network host name, a registration identifier, a registration password, or any combination thereof. In some implementations, the configuration file includes multiple fields of the same type. For example, a configuration file can include a primary DNS address and a secondary DNS address. In some implementations, the configuration file includes multiple passwords for accessing separate sets of settings or for accessing one or more of the servers referenced by the other fields in the configuration file. For example, one or more registration identifiers and passwords can be used to access the VoIP server 142, the time server 140, and/or the DHCP server 136.

The process 600 receives (606) a user selection in the GUI of one or more elements from the structure. For example, a user can select a FloorNum element in the variable selection control 514 during creation of a formula for the static IP address of the network telephone devices 116a-j. Other structure elements from the buildings can include, for example, a building number, floor number, room number, or phone location number. In some implementations, other fields from the configuration file, such as the configuration ID, and/or the phone number of the network telephone device, can be selected by a user for inclusion in the formula. User selection of elements can, for example, include pushing the element onto the stack 502 or otherwise adding the element to a formula in the stack 502.

The process 600 receives (608) a user input in the GUI indicating one or more operations to be performed on the selected elements. For example, a user can select a modulus operation from the buttons 518. The modulus operation can be performed on a previously selected RoomNum variable and a divisor of one hundred. Other operations can include arithmetic operations such as addition, subtraction, multiplication, and division, or text operations such as converting numbers to text or concatenating text.

The process 600 identifies (610) values for the selected elements for each of the corresponding network telephone devices based on the structure. For example, the room number and floor number for each of the network telephone devices 116a-j is identified. In particular, the administrator console 104 can identify a floor number of one, a room number of one hundred and one, and a location number of two for the network telephone device 116c. The network telephone devices 116a-b have a floor number of one, a room number of one hundred and one, and location numbers of zero and one, respectively. The network telephone device 116i has a floor number of three, a room number of three hundred and two, and a location number of zero. In some implementations, the room number and floor number for each of the network telephone devices 116a-j is stored in memory on the administrator console 104. In other implementations, values for the selected elements are identified during evaluation of the formula.

The process 600 evaluates (612) the operations using the values for the selected elements to determine values for the field for each of the corresponding network telephone devices. For example, operations in a formula created with the GUIs 400 and 500 can be evaluated. The formula is separately evaluated for each of the network telephone devices 116a-j using the values of the selected elements.

The process 600 generates (614) the configuration files for each of the corresponding network telephone devices using the corresponding values for the field. For example, the administrator console 104 generates a separate configuration file for each of the network telephone devices 116a-j.

The process 600 stores (616) the configuration files in a memory. For example, the administrator console 104 can store each of the configuration files in memory located in the administrator console 104 or upload the configuration files to the file server 106 for storage with the configuration files 134.

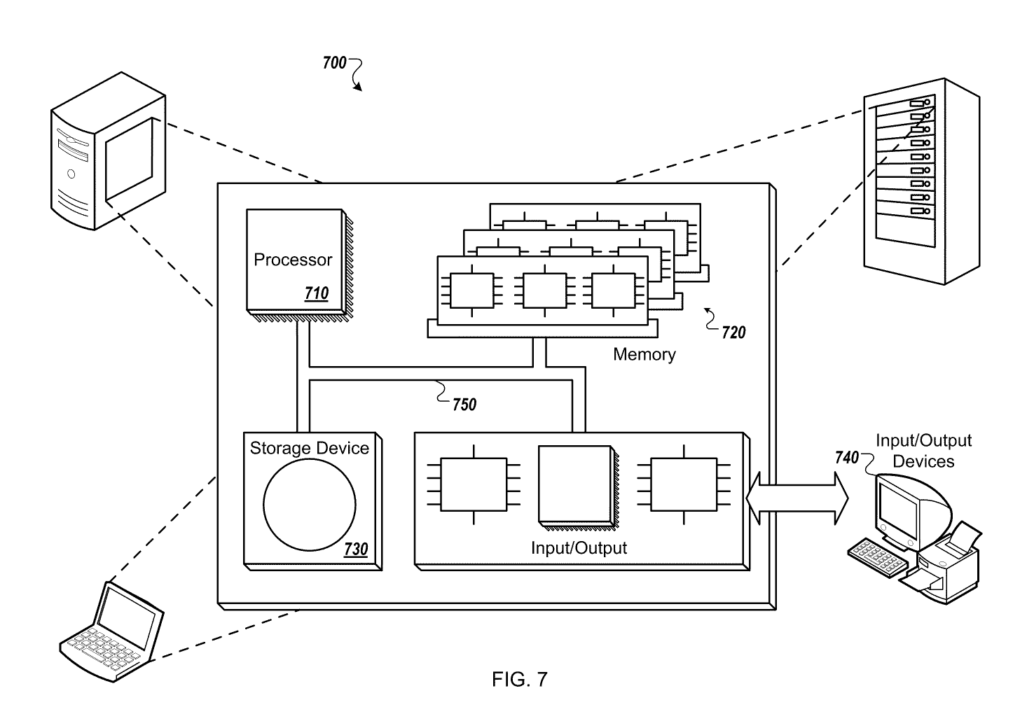

FIG. 7 is a schematic diagram of a computing system 700. The computing system 700 can be used for the operations described in association with any of the computer-implement methods and systems described previously, according to some implementations. The computing system 700 includes a processor 710, a memory 720, a storage device 730, and an input/output device 740. Each of the processor 710, the memory 720, the storage device 730, and the input/output device 740 are interconnected using a system bus 750. The processor 710 is capable of processing instructions for execution within the computing system 700. In some implementations, the processor 710 is a single-threaded processor. In some implementations, the processor 710 is a multi-threaded processor. The processor 710 is capable of processing instructions stored in the memory 720 or on the storage device 730 to display graphical information for a user interface on the input/output device 740.

The memory 720 stores information within the computing system 700. In some implementations, the memory 720 is a computer-readable medium. In some implementations, the memory 720 is a volatile memory unit. In some implementations, the memory 720 is a non-volatile memory unit.

The storage device 730 is capable of providing mass storage for the computing system 700. In some implementations, the storage device 730 is a computer-readable medium. In various different implementations, the storage device 730 may be a floppy disk device, a hard disk device, an optical disk device, or a tape device.

The input/output device 740 provides input/output operations for the computing system 700. In some implementations, the input/output device 740 includes a keyboard and/or pointing device. In some implementations, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM (erasable programmable read-only memory), EEPROM (electrically erasable programmable read-only memory), and flash memory devices; magnetic disks such as internal hard disks and removable disks; magneto-optical disks; and CD-ROM (compact disc read-only memory) and DVD-ROM (digital versatile disc read-only memory) disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN (local area network), a WAN (wide area network), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method for generating a plurality of configuration files that are individually customized for a corresponding plurality of network telephone devices for voice communication comprising:
receiving one or more user inputs in a graphical user interface (GUI) on a computing device indicating a structure of one or more buildings in which the network telephone devices are located;
receiving a user selection in the GUI of a field to be configured from among a plurality of fields to be included in the configuration files;
receiving a user selection in the GUI of one or more elements from the structure;
receiving a user input in the GUI indicating one or more operations to be performed on the selected elements;
identifying values for the selected elements for each of the corresponding network telephone devices based on the structure;
evaluating the operations using the values for the selected elements to determine values for the field for each of the corresponding network telephone devices;
generating the configuration files for each of the corresponding network telephone devices using the corresponding values for the field; and
storing the configuration files in a memory.

2. The method of claim 1, wherein the network telephone devices include one or more voice over Internet Protocol (IP) telephones.

3. The method of claim 1, wherein the network telephone devices include one or more voice over Internet Protocol (IP) telephony adapters for corresponding analog telephones.

4. The method of claim 2 or claim 3, wherein the fields include for each of the corresponding network telephone devices one or more of a static IP address, a unique configuration identifier, a network host name, a display message, a telephone number, a telephone extension, a registration identifier, and a registration password.

5. The method of claim 1, wherein the elements from the structure include one or more of identifiers of the buildings, identifiers of one or more floors in the buildings, identifiers of one or more rooms on the floors, identifiers of one or more telephone locations in the rooms, and identifiers of one or more types of telephones.

6. The method of claim 5, wherein one or more of the identifiers of the buildings, the identifiers of the floors, the identifiers of the rooms, and the identifiers of the telephone locations are numeric.

7. The method of claim 6, wherein the operations include one or more mathematical operations performed on the numeric ones of the identifiers of the buildings, the identifiers of the floors, the identifiers of the rooms, and the identifiers of the telephone locations.

8. The method of claim 1, wherein the operations include one or more logic operations.

9. The method of claim 1, wherein the operations include one or more text manipulation operations.

10. The method of claim 1, further comprising receiving a user input including one or more phone templates having default values for the fields of the configuration files.

11. The method of claim 10, wherein receiving the user inputs indicating the structure includes receiving a room type that specifies a number of telephone locations in rooms having the room type and ones of the phone templates assigned to each of the telephone locations.

12. The method of claim 11, wherein receiving the user inputs indicating the structure includes receiving one or more ranges of identifiers of rooms having the room type.

13. The method of claim 12, further comprising receiving a user request in the GUI to copy at least one of the ranges to another range.

14. The method of claim 1, further comprising transmitting the configuration files to a file server.

15. A computer program product, encoded on a computer-readable medium, operable to cause one or more processors to perform operations for generating a plurality of configuration files that are individually customized for a corresponding plurality of network telephone devices for voice communication comprising:
receiving one or more user inputs in a graphical user interface (GUI) on a computing device indicating a structure of one or more buildings in which the network telephone devices are located;
receiving a user selection in the GUI of a field to be configured from among a plurality of fields to be included in the configuration files;
receiving a user selection in the GUI of one or more elements from the structure;
receiving a user input in the GUI indicating one or more operations to be performed on the selected elements;
identifying values for the selected elements for each of the corresponding network telephone devices based on the structure;
evaluating the operations using the values for the selected elements to determine values for the field for each of the corresponding network telephone devices;
generating the configuration files for each of the corresponding network telephone devices using the corresponding values for the field; and
storing the configuration files in a memory.

16. The computer program product of claim 15, wherein the elements from the structure include one or more of identifiers of the buildings, identifiers of one or more floors in the buildings, identifiers of one or more rooms on the floors, identifiers of one or more telephone locations in the rooms, and identifiers of one or more types of telephones, and wherein one or more of the identifiers of the buildings, the identifiers of the floors, the identifiers of the rooms, and the identifiers of the telephone locations are numeric, and wherein the operations include one or more mathematical operations performed on the numeric ones of the identifiers of the buildings, the identifiers of the floors, the identifiers of the rooms, and the identifiers of the telephone locations.

17. The computer program product of claim 15, wherein the operations include one or more logic operations.

18. The computer program product of claim 15, wherein the operations include one or more text manipulation operations.

19. The computer program product of claim 15, further comprising receiving a user input including one or more phone templates having default values for the fields of the configuration files, and wherein receiving the user inputs indicating the structure includes receiving a room type that specifies a number of telephone locations in rooms having the room type and ones of the phone templates assigned to each of the telephone locations and receiving one or more ranges of identifiers of rooms having the room type.

20. The computer program product of claim 19, further comprising receiving a user request in the GUI to copy at least one of the ranges to another range.
